(19) United States
(12) Patent Application Publication
(10) Pub. No.: US 2017/0185832 A1
(43) Pub. Date: Jun. 29, 2017

(54) SYSTEM AND METHOD FOR VERIFYING EXTRACTION OF MULTIPLE DOCUMENT IMAGES FROM AN ELECTRONIC DOCUMENT

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/398,108

(22) Filed: Jan. 4, 2017

Related U.S. Application Data
(63) Continuation-in-part of application No. 15/361,934, filed on Nov. 28, 2016.
Application No. 15/361,934 is a continuation-in-part of application No. 15/013,284, filed on Feb. 2, 2016.
(60) Provisional application No. 62/287,454, filed on Jan. 27, 2016.
(60) Provisional application No. 62/260,553, filed on Nov. 29, 2015.
(60) Provisional application No. 62/261,355, filed on Dec. 1, 2015.
(60) Provisional application No. 62/111,690, filed on Feb. 4, 2015.

(51) Int. Cl. G06K 9/00; G06K 9/34; G06K 9/62

(52) U.S. Cl. CPC G06K 9/00456; G06K 9/6201; G06K 9/344

(57) ABSTRACT

A system and method for verifying an extraction of a plurality of document images from an electronic document. The method includes analyzing the electronic document to determine at least one transaction parameter of the transaction, the electronic document including the plurality of document images; creating a template for the transaction, wherein the template is a structured dataset including the determined at least one transaction parameter; determining, for each document image of the electronic document, at least one visual identifier based on the created template, wherein each determined visual identifier is one of the at least one transaction parameter; obtaining the plurality of document images of the electronic document, wherein the obtained document images are extracted from the electronic document during the extraction; and determining, based on the determined visual identifiers and the obtained document images, whether the extraction is verified.

### CROSS-REFERENCE TO RELATED APPLICATIONS

This application claims the benefit of U.S. Provisional Application No. 62/287,454 filed on Jan. 27, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. This application is also a continuation-in-part of U.S. patent application Ser. No. 15/013,284 filed on Feb. 2, 2016, now pending, which claims the benefit of U.S. Provisional Application No. 62/111,690 filed on Feb. 4, 2015. The contents of the above-referenced applications are hereby incorporated by reference.

### TECHNICAL FIELD

The present disclosure relates generally to extracting multiple images of documents from an electronic document, and more particularly to verifying successful extraction of document images from an electronic document.

### BACKGROUND

As businesses increasingly rely on technology to manage data related to operations such as invoice and purchase order data, suitable systems for properly managing and validating data have become crucial to success. Particularly for large businesses, the amount of data utilized daily by businesses can be overwhelming. Accordingly, manual review and validation of such data is impractical, at best. However, disparities between recordkeeping documents can cause significant problems for businesses such as, for example, failure to properly report earnings to tax authorities.

Typically, to reclaim value-added tax (VAT) paid during a transaction, evidence in the form of documentation indicating information related to the transaction (such as an invoice or receipt) must be submitted to an appropriate refund authority (e.g., a tax agency of the country refunding the VAT). If the information in the submitted documentation does not match the information submitted in the reclaim request, the request is denied and no reclaim is granted. To this end, employees of organizations often manually select and submit the required documentation for VAT reclaims in the form of electronic documents (e.g., an image file showing a scan of an invoice or receipt). This manual selection introduces potential for human error due to, for example, an employee providing incorrect information in the request and/or submitting unintended documentation (e.g., an invoice for another transaction). Existing solutions for automatically verifying transactions face challenges in utilizing electronic documents containing at least partially unstructured data.

Additionally, the large numbers of invoices generated by a typical enterprise ultimately results in creation of a multitude of files corresponding to the invoices. Existing solutions typically require that each invoice is contained in a separate file and, consequently, require individual scanning or otherwise capturing of each invoice. Such manual individual scanning wastes time and resources, and ultimately subject the process to more potential for human error. Moreover, each invoice must typically be manually reviewed to ensure it was correctly captured.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Some embodiments disclosed herein include a method for verifying extraction of a plurality of document images from an electronic document. The method comprises: analyzing the electronic document to determine at least one transaction parameter of the transaction, the electronic document inicluding the plurality of document images; creating a template for the transaction, wherein the template is a structured dataset including the determined at least one transaction parameter; determining, for each document image of the electronic document, at least one visual identifier based on the created template, wherein each determined visual identifier is one of the at least one transaction parameter; obtaining the plurality of document images of the electronic document, wherein the obtained document images are extracted from the electronic document during the extraction; and determining, based on the determined visual identifiers and the obtained document images, whether the extraction is verified

Some embodiments disclosed herein also include a non-transitory computer readable medium having stored thereon instructions for causing a processing circuitry to perform a process, the process comprising: analyzing an electronic document to determine at least one transaction parameter of the transaction, the electronic document including a plurality of document images; creating a template for the transaction, wherein the template is a structured dataset including the determined at least one transaction parameter; determining, for each document image of the electronic document, at least one visual identifier based on the created template, wherein each determined visual identifier is one of the at least one transaction parameter; obtaining the plurality of document images of the electronic document, wherein the obtained document images are extracted from the electronic document during the extraction; and determining, based on the determined visual identifiers and the obtained document images, whether the extraction is verified.

Some embodiments disclosed herein also include a system for verifying extraction of a plurality of document images from an electronic document. The system comprises: a processing circuitry; and a memory, the memory containing instructions that, when executed by the processing circuitry, configure the system to: analyze the electronic document to determine at least one transaction parameter of the transaction, the electronic document including the plurality of document images; create a template for the transaction, wherein the template is a structured dataset including the determined at least one transaction parameter; determine, for each document image of the electronic document, at least one visual identifier based on the created template, wherein each determined visual identifier is one of the at least one transaction parameter; obtain the plurality of document images of the electronic document, wherein the obtained document images are extracted from the electronic document during the extraction; and determine, based on the determined visual identifiers and the obtained document images, whether the extraction is verified.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of an extraction verifier according to an embodiment.

FIG. 3 is a flowchart illustrating a method for verifying extraction of a plurality of document images from an electronic document according to an embodiment.

FIG. 4 is a flowchart illustrating a method for creating a dataset based on an electronic document according to an embodiment.

FIG. 5 is a flowchart illustrating a method for extracting a plurality of document images from an electronic document.

FIGS. 6A-6C are flowcharts illustrating methods for extracting a document image from an electronic document via cutting, cropping, and copying, respectively.

FIGS. 7A-7E are example images showing an electronic document including a plurality of document images to be extracted.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for verifying extraction of a plurality of document images from an electronic document. A structured dataset template of transaction attributes is created for an electronic document including a plurality of document images. Each document image may be or may include an image showing an invoice, a receipt, or any other document. Based on the created template, a plurality of visual identifiers is determined. Extracted document images of the electronic document are obtained. Based on the obtained extracted document images and the determined visual identifiers, it is determined if the extraction is verified. In an embodiment, if the extraction is not verified, the document images may be extracted from the electronic document.

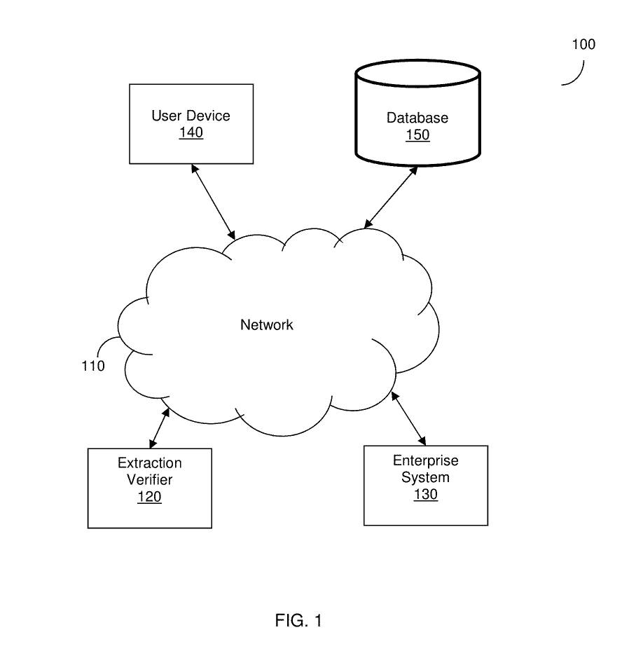

FIG. 1 shows an example network diagram 100 utilized to describe the various disclosed embodiments. In the example network diagram 100, an extraction verifier 120, an enterprise system 130, a user device 140, and a database 150 are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or representatives of the enterprise as well as data related to the enterprise itself. The enterprise may be, but is not limited to, a business whose employees may purchase goods and services subject to VAT taxes while abroad. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image, a text file, a spreadsheet file, etc.). Data included in each electronic document may be structured, semi-structured, unstructured, or a combination thereof. The structured or semi-structured data may be in a format that is not recognized by the extraction verifier 120 and, therefore, may be treated as unstructured data.

Alternatively or collectively, the data stored by the enterprise system 130 may include document images extracted from electronic documents. Each document image may be or may include an image showing, e.g., an invoice, a tax receipt, a purchase number record, a VAT reclaim request, an employee expense report, and the like. For example, an electronic document may be an image including a plurality of document images, each document image showing a scanned invoice.

The user device 140 may be, but is not limited to, a personal computer, a laptop, a tablet computer, a smartphone, a wearable computing device, a scanner, or any other device. The user device 140 may send, to the enterprise system 130, to the extraction verifier 120, or both, an electronic document including a plurality of document images to be extracted and verified. For example, the user device 140 may be a smartphone that captures an image showing a plurality of receipts to be utilized as the electronic document. As another example, the user device 140 may be a scanner that scans a plurality of invoices to be utilized as the electronic document.

In an embodiment, the extraction verifier 120 is configured to create a template based on transaction parameters identified using machine vision of an electronic document including a plurality of document images. In a further embodiment, the extraction verifier 120 may be configured to retrieve the electronic document from, e.g., the enterprise system 130. In another embodiment, the extraction verifier 120 may be configured to receive the electronic document from, e.g., the user device 140. Based on the created template, the extraction verifier 120 is configured to retrieve data evidencing the transaction.

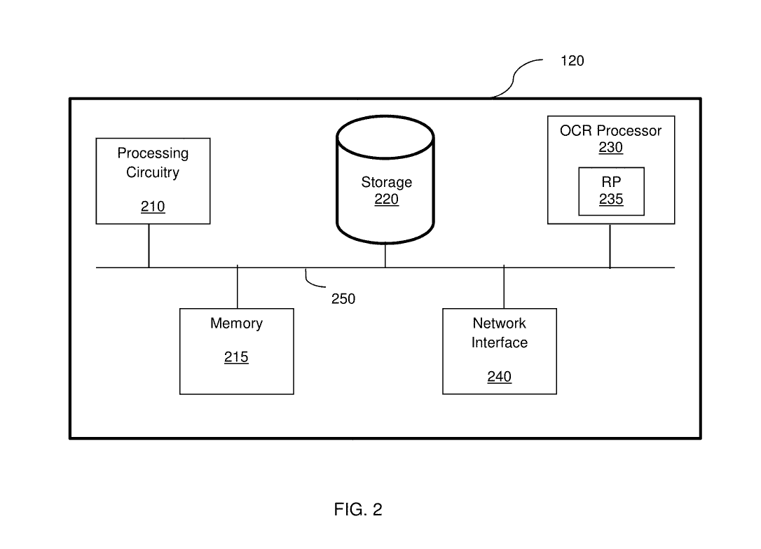

In an embodiment, the extraction verifier 120 is configured to create a dataset based on an electronic document including data that is at least partially unstructured (e.g., unstructured data, semi-structured data, or structured data having an unknown structure). To this end, the extraction verifier 120 may be further configured to utilize optical character recognition (OCR) or other image processing to determine data in the electronic document. The extraction verifier 120 may therefore include or be communicatively connected to a recognition processor (e.g., the recognition processor 235, FIG. 2).

In an embodiment, the extraction verifier 120 is configured to analyze the created datasets to identify transaction parameters related to transactions indicated in the electronic document. In an embodiment, the extraction verifier 120 is configured to create a template based on the created dataset. The template is a structured dataset including the identified transaction parameters.

In an embodiment, the extraction verifier 120 is configured to verify an extraction of a plurality of document images from an electronic document. In a further embodiment, the extraction verifier 120 is configured to create a template for the electronic document and to determine, based on the created template, a plurality of visual identifiers. In an embodiment, each of the determined visual identifiers is one of the transaction parameters. In a further embodiment, the visual identifiers may be determined based on at least one predetermined type of visual identifier required for verifying extraction. In yet a further embodiment, the visual identifiers may be determined based on a structure of the created template. In yet a further embodiment, the at least one predetermined type of required visual identifier may relate to fields of templates. As a non-limiting example, when the at least one predetermined type of required visual identifier includes a merchant identifier and a purchase order number, the determined visual identifiers may include transaction parameters in the fields “Merchant ID” and “Order Number” of the created template.

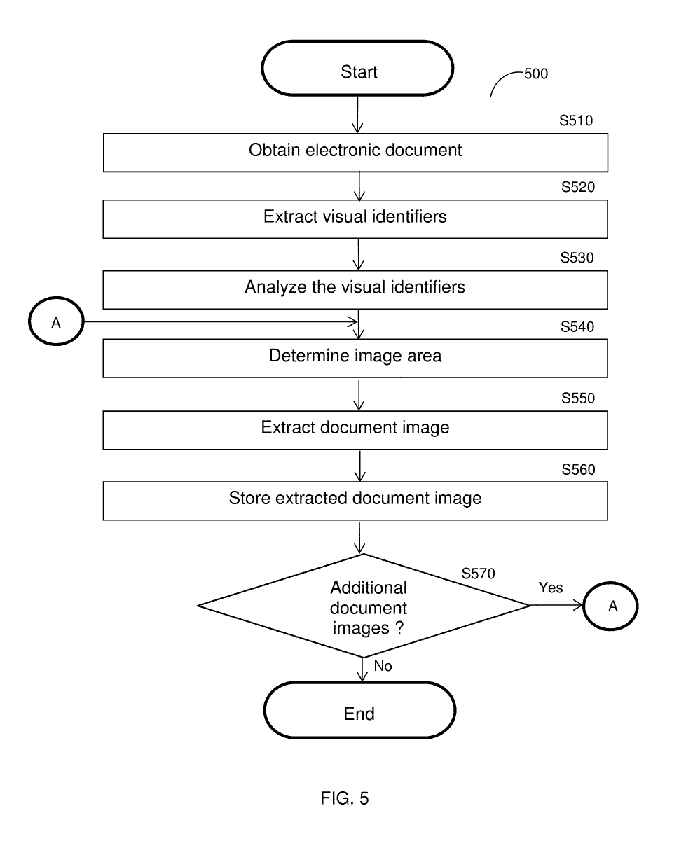

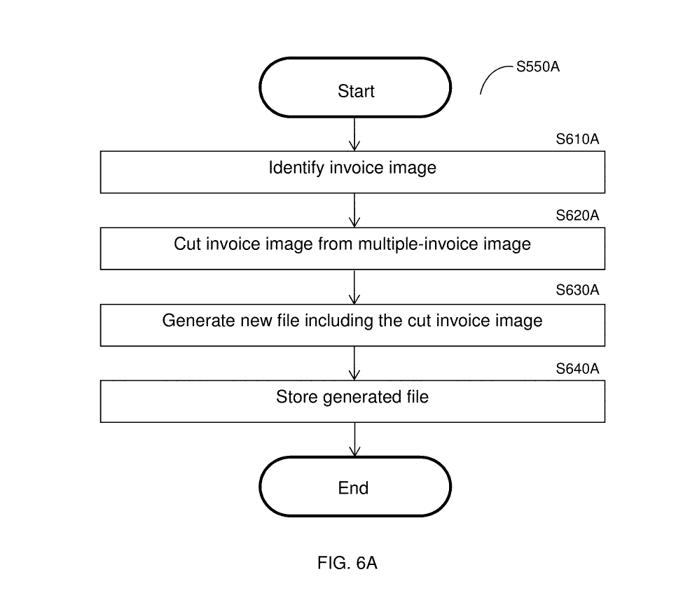

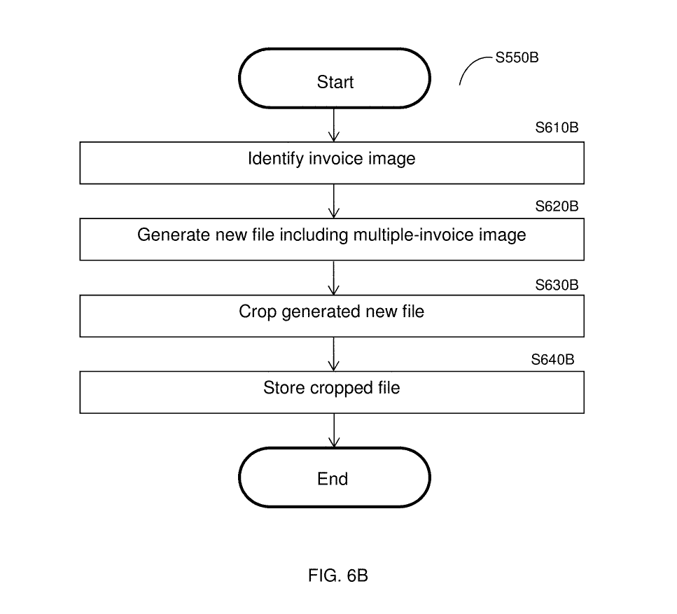

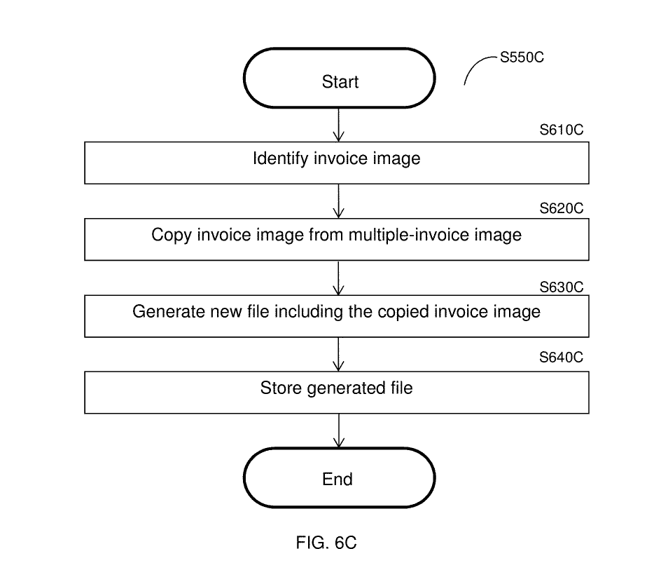

In an embodiment, the extraction verifier 120 is configured to obtain the document images extracted from an electronic document. The extracted document images may be, e.g., previously extracted document images received or retrieved from the enterprise system 130. In another embodiment, the extraction verifier 120 may be configured to extract the plurality of document images from the electronic document. Extracting document images of an electronic document is described further herein below with respect to FIGS. 5 and 6A-6C.

In an embodiment, based on the obtained extracted document images and the determined visual identifiers, the extraction verifier 120 is configured to determine whether the extraction is verified. The extraction may be verified when, e.g., all document images of the electronic document have been extracted and identified (based on, e.g., the visual identifiers). In a further embodiment, the extraction verifier 120 may be further configured to compare the determined visual identifiers to each extracted document image. In yet a further embodiment, the extraction verifier 120 may be configured to analyze each extracted document image using machine vision to determine data included therein, and the determined data of the extracted document images may be compared to the visual identifiers. In a further embodiment, the extraction verifier 120 is configured to determine that the extraction is verified when at least each determined visual identifier or each combination of determined visual identifiers is identified in one of the extracted document images.

In another embodiment, the extraction verifier 120 may be configured to determine whether any of the document images of the electronic document are duplicates (e.g., duplicates of a particular receipt). In a further embodiment, the extraction verifier 120 may be configured to remove duplicate document images.

In an embodiment, when it is determined that the extraction is not verified, the extraction verifier 120 may be configured to extract the plurality of document images from the electronic document. The extraction may include, but is not limited to, cutting, cropping, or copying each document image of the electronic document. In a further embodiment, the extraction verifier 120 may be configured to store the extracted document images in the database 150. In another embodiment, when the plurality of document images is extracted by the extraction verifier 120, the extraction verifier 120 is configured to re-verify the extraction to verify that the extraction was successful.

It should be noted that the embodiments described herein above with respect to FIG. 1 are described with respect to one enterprise system 130 and one user device 140 merely for simplicity purposes and without limitation on the disclosed embodiments. Multiple enterprise systems, user devices, or both, may be equally utilized without departing from the scope of the disclosure.

FIG. 2 is an example schematic diagram of the extraction verifier 120 implemented according to an embodiment. The extraction verifier 120 includes a processing circuitry 210 coupled to a memory 215, a storage 220, an optical character recognition (OCR) processor 230, and a network interface 240. In a further embodiment, the components of the extraction verifier 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 210, cause the processing circuitry 210 to perform the various processes described herein. Specifically, the instructions, when executed, cause the processing circuitry 210 to verify extractions of document images from an electronic document, as described herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a dataset including data required for verification an extraction of document images from an electronic document.

The network interface 240 allows the extraction verifier 120 to communicate with the enterprise system 130, the user device 140, the database 150, or a combination of, for the purpose of, for example, retrieving data, obtaining electronic documents, obtaining extracted document images of electronic documents, storing data, combinations thereof, and the like.

It should be understood that the embodiments described herein are not limited to the specific architecture illustrated in FIG. 2, and other architectures may be equally used without departing from the scope of the disclosed embodiments.

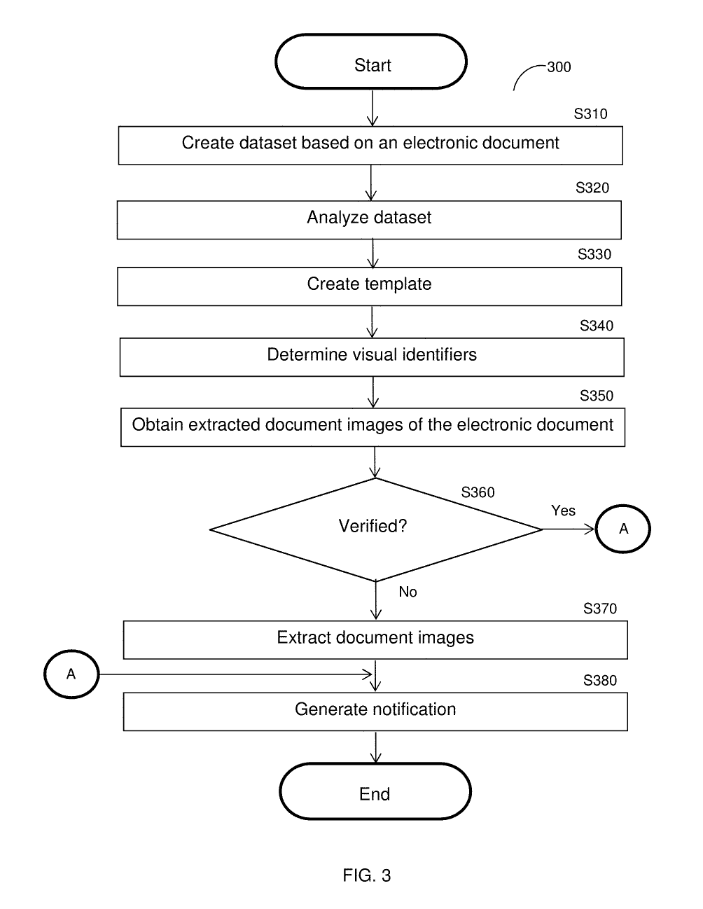

FIG. 3 is an example flowchart 300 illustrating a method for verifying an extraction of a plurality of document images from an electronic document according to an embodiment. In an embodiment, the method may be performed by an extraction verifier (e.g., the extraction verifier 120, FIG. 1).

At S310, a dataset is created based on an electronic document including a plurality of document images. The electronic document may include, but is not limited to, unstructured data, semi-structured data, structured data with structure that is unanticipated or unannounced, or a combination thereof. Each document image may be an image showing, e.g., an invoice, a receipt, and the like. For example, the electronic document may be an image showing multiple invoices, receipts, or a combination thereof.

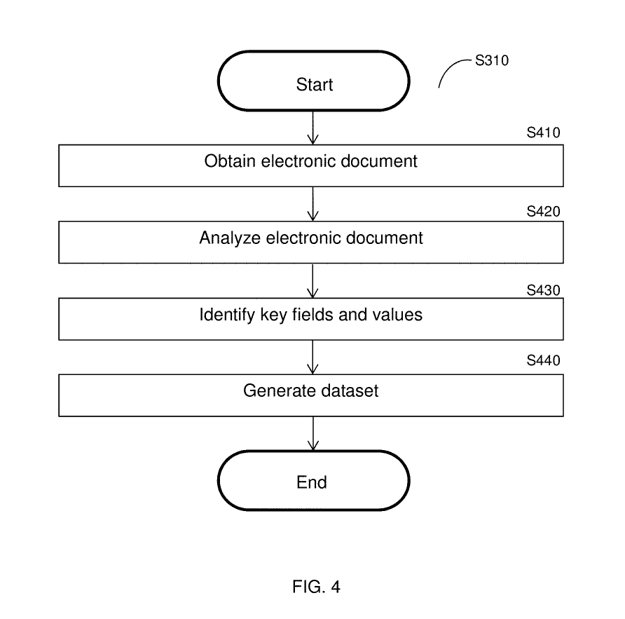

In an embodiment, S310 may further include analyzing the electronic document using optical character recognition (OCR) to determine data in the electronic document, identifying key fields in the data, identifying values in the data, or a combination thereof. Creating datasets based on electronic documents is described further herein below with respect to FIG. 4.

At S320, the dataset is analyzed. In an embodiment, analyzing the dataset may include, but is not limited to, determining transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In a further embodiment, analyzing the dataset may also include identifying the transaction based on the dataset.

At S330, a template is created based on the dataset. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S340, based on the created template, visual identifiers are determined. In an embodiment, each of the determined visual identifiers is one of the transaction parameters. In another embodiment, embodiment, at least one visual identifier may be determined for each document image of the electronic document. In a further embodiment, the visual identifiers may be determined based on at least one predetermined type of visual identifier required for verifying extraction. In yet a further embodiment, the visual identifiers may be determined based on a structure of the created template. In yet a further embodiment, the at least one predetermined type of required visual identifier may relate to fields of templates. As a non-limiting example, if a predetermined list of types of visual identifiers includes an invoice identification number, the at least one visual identifier determined for each document image of the electronic document includes one value in a field “Document ID” such that, if the “Document ID” field includes the invoice identification numbers “11111”, “22222”, and “33333”, the determined visual identifiers for each of three document image of the electronic document include the respective invoice identification number in the “Document ID” field.

In another embodiment, the visual identifiers may be determined further based on metadata associated with the electronic document. The metadata may indicate, for example, a number of document images of the electronic document (e.g., a number of invoices shown in the electronic document), at least one pointer to data associated with the document images of the electronic document (e.g., a pointer to a location in a database or other data source including information related to transactions indicated in invoices shown in an image), and the like. For example, if the metadata indicates that 5 invoices are included in an electronic document, at least one visual identifier for each of 5 document images of the electronic document may be determined.

In an embodiment, the visual identifiers may be determined based on one or more predetermined threshold visual identifier requirements (e.g., a number of visual identifiers, a particular group of visual identifiers, or both). As a non-limiting example, threshold visual identifier requirements may require, for each document image of the electronic document, determination of at least one of an invoice number; a combination of date and time; a combination of merchant identifier, price, and buyer identifier; and the like.

At S350, the extracted document images of the electronic document are obtained. The obtained document images may be extracted as described further herein below with respect to FIG. 5.

At S360, it is determined, based on the determined visual identifiers and the obtained extracted document images, whether the extraction is verified and, if so, execution continues with S380; otherwise, execution continues with S370. In an embodiment, S360 may include comparing the determined visual identifiers to the extracted document images to determine whether the at least one visual identifier determined for each document image is in one of the extracted document images.

In a further embodiment, S360 may also include determining whether a number of sets of at least one visual identifier of the determined visual identifiers is equal to a number of extracted document images. As a non-limiting example, if the determined visual identifiers include 9 sets of visual identifiers, each set including a price, a seller name, and a buyer name, but 10 extracted document images were obtained, it is determined that the extraction is not verified.

In another embodiment, S360 may also include analyzing, using machine vision, each extracted document image to identify data included therein. The identified data of the extracted document images may be compared to the visual identifiers.

In yet another embodiment, S360 may further include determining whether any of the extracted document images are duplicates. Two extracted document images of the electronic document may be duplicates if, for example, the same set of at least one visual identifier is matched to both document images. As a non-limiting example, if the determined visual identifiers include a transaction identifier “12345” which is included in two receipt images shown in the electronic document, the receipt images may be determined to be duplicates. One (or more, if there is more than 1 duplicate) of the duplicate document images may be removed from the extracted document images.

As a non-limiting example for verifying an extraction, visual identifiers determined for an electronic document include the following sets of visual identifiers: (Mar. 12, 2016; 2:01 PM), (Jul. 2, 2016; 5:57 PM), and (Apr. 20, 2015; 10:44 AM). Each set of visual identifiers corresponds to an invoice shown in the electronic document. The invoices that were previously extracted from the electronic document are retrieved. The retrieved invoices are analyzed using machine vision to determine data included therein. The determined sets of visual identifiers are compared to the determined data, and it is determined that a first invoice includes “Mar. 12, 2016” and “2:01 PM”, that a second invoice includes “Jul. 2, 2016” and “5:57 PM”, and that a third invoice includes “Apr. 20, 2015” and “10:44 AM”. Thus, it is determined that all sets of visual identifiers are represented by the document images and, accordingly, the extraction is verified.

At optional S370, when it is determined that the extraction is not verified, the plurality of document images may be extracted from the electronic document. In a further embodiment S370 may include re-verifying based on the extraction performed at S370. Extracting document images of an electronic document is described further herein below with respect to FIG. 5.

At optional S380, a notification may be generated. The notification may indicate whether the extraction is verified.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned or otherwise captured image from a user device) or retrieving the electronic document (e.g., retrieving the electronic document from an enterprise system or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to Dec. 12, 2005. As another example, if a name is presented as “Mo$den”, this will change to “Mosden”. The cleaning process may be performed using external information resources, such as dictionaries, calendars, an enterprise database, and the like.

In a further embodiment, it is checked if the extracted pieces of data are completed.

For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

FIG. 5 is an example flowchart 500 illustrating a method for extracting a plurality of document images of an electronic document.

At S510, an electronic document including a plurality of document images is received. The plurality of document images in the electronic document may be unorganized such that they are not suitable for immediate processing.

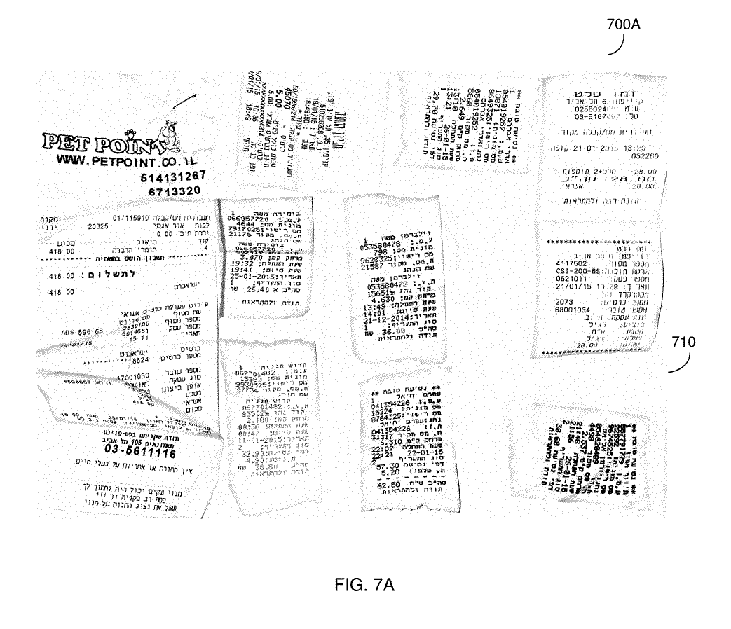

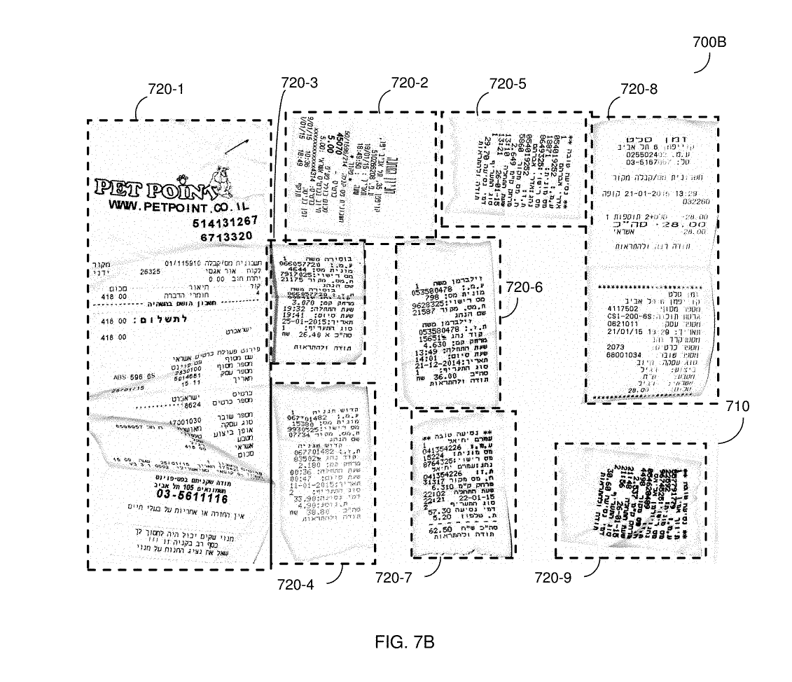

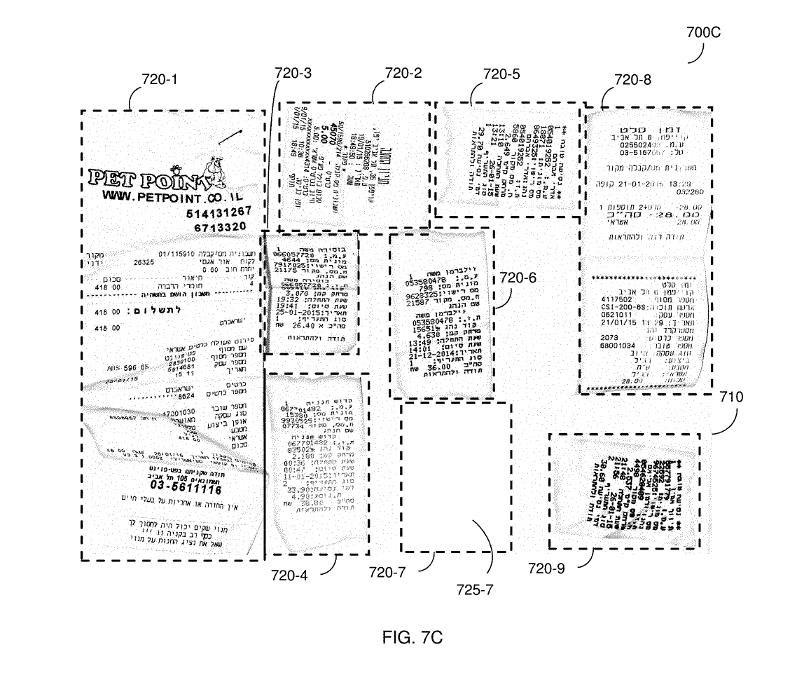

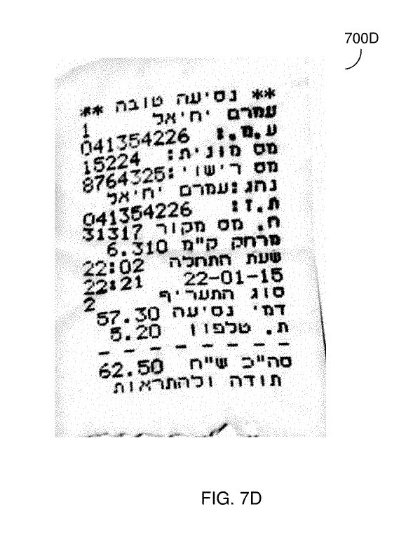

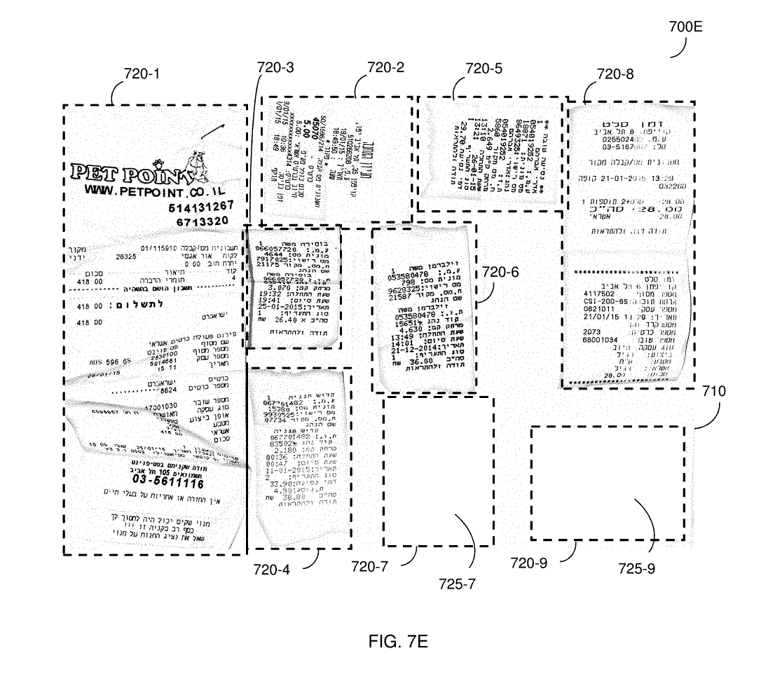

An example electronic document including a plurality of document images may be seen in FIG. 7A, which shows a screenshot 700A illustrating a multiple-invoice image 710 including a invoice images. The invoice images are unorganized such that some of the invoice images are upside down, rotated, and positioned at random sections within the multiple-invoice image 710. Each invoice image shows an invoice which includes information related to a purchase of a good or service.

At S520, visual identifiers are extracted from the electronic document. Each visual identifier indicates information related to a document image of the electronic document. The visual identifiers may include, but are not limited to, a document identification number (e.g., an invoice number), a code (e.g., a QR code, a bar code, etc.), a transaction number, a name of a business, an address of a business, an identification number of a business, a total price, a currency, a method of payment (e.g., cash, check, credit card, debit card, digital currency, etc.), a date, a type of product, a price per product, a graphic (e.g., a graphic utilized as a mark representing a business entity), and so on.

In an embodiment, S520 includes analyzing, using machine vision, the electronic document to determine data therein. In a further embodiment, S520 may also include generating a structured dataset template based on data in the electronic document and determining, based on the template, transaction parameters to be utilized as the visual identifiers as described further herein above.

At S530, the extracted visual identifiers are analyzed. The analysis may yield identification of metadata associated with the electronic document. Such metadata may include, but is not limited to, a number of document images of the electronic document, pointer data indicating information related to one or more document images of the electronic document available via one or more storage units, and so on.

At S540, an image area of each document image of the electronic document is determined based on the analysis. In an embodiment, the determination may include identifying a boundary of each document image of the electronic document. The image area of a document image of an electronic document may be defined as the area contained within the boundary of the document image.

Example determined image areas may be seen in FIG. 7B, which shows an example screenshot 700B illustrating a multiple-invoice image 710 including a plurality of invoices, with an invoice image of each invoice defined by an image area within boundaries 720-1 through 720-9 (hereinafter referred to individually as a boundary 720 and collectively as boundaries 720, merely for simplicity purposes). In the example screenshot 700B, each boundary 720 is rectangular and occupies a textless border around each invoice.

At S550, a document image is extracted from the multiple-invoice image based on its respective image area. The extraction may include generating a new file for the invoice image, and may further include cutting, cropping, and/or copying the invoice image in the captured image. Example methods for extracting image invoice document images of an electronic document including a multiple-invoice image are described further herein below with respect to FIGS. 6A through 6C.

Extracting invoice image document images of an electronic document from a multiple-invoice image via cutting may be seen in FIG. 7C, which shows an example screenshot 700C illustrating the multiple-invoice image 710 including the plurality of invoices with invoice images defined by the boundaries 720. In the example screenshot 700C, the invoice image 725-7 enclosed by the boundary 720-7 has been cut from the captured image. Additional invoice images may be further cut from the captured image as demonstrated in FIG. 7E until all invoice images identified in the multiple-invoice image have been removed.

FIG. 7D shows an example screenshot 400D illustrating the cut invoice image 725-7. A new file including only the cut invoice image 725-7 may be generated based on the cutting.

At optional S560, the extracted invoice image may be stored as a file in, for example, a database (e.g., the database 150). Stored invoice images may be subsequently processed further. For example, stored invoice images may be analyzed for value added tax (VAT) reclaim eligibility, sent to a refund agency, used to verify extractions, and the like.

At S570, it is determined whether additional document images are to be extracted from the electronic document and, if so, execution continues with S540; otherwise, execution terminates.

Extraction of an additional invoice image from a multiple-invoice image may be seen in FIG. 7E, which shows an example screenshot 700E illustrating the multiple-invoice image 710 including the plurality of invoices with invoice images defined by the boundaries 720. In the example screenshot 700E, the invoice image 725-9 enclosed by the boundary 720-9 has been cut from the multiple-invoice image in addition to the invoice image 725-7 enclosed by the boundary 720-7. Additional cuts would therefore remove each of the invoice images enclosed by the boundaries 720-1 through 720-6 and 720-8 until the multiple-invoice image contains no document images showing invoice images to be extracted.

FIG. 6A is an example flowchart S550A illustrating a method for extracting an invoice image from a multiple-invoice image via cutting.

At S610A, an invoice image featured in a multiple-invoice image is identified based on its image area. At S620A, the identified invoice image is cut from the multiple-invoice image. The cut image is removed from the captured image such that it is no longer featured in the multiple-invoice image. At S630A, a new file including the cut invoice image is generated. At S640A, the generated file may be stored in, e.g., a database.

FIG. 6B is an example flowchart S550B illustrating a method for extracting an invoice image from a multiple-invoice file via cropping.

At S610B, an invoice image featured in a multiple-invoice image is identified based on its image area. At S620B, a file including the multiple-invoice image is generated. At S630B, the new file is cropped respective of the identified invoice image. The cropping may include shrinking the size of the generated file such that the cropped file only includes the invoice image. At S640B, the cropped new file may be stored in, e.g., a database.

FIG. 6C is an example flowchart S550C illustrating a method for extracting an invoice image from a multiple-invoice file via copying.

At S610C, an invoice image featured in a multiple-invoice image is identified based on its image area. At S620C, the identified invoice image is copied from the multiple-invoice image. At S630C, a file including the copied invoice image is generated. At S640C, the generated file may be stored in, e.g., a database.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for verifying an extraction of a plurality of document images from an electronic document, comprising:
analyzing the electronic document to determine at least one transaction parameter of a transaction, the electronic document including the plurality of document images;
creating a template for the transaction, wherein the template is a structured dataset including the determined at least one transaction parameter;
determining, for each document image of the electronic document, at least one visual identifier based on the created template, wherein each determined visual identifier is one of the at least one transaction parameter;
obtaining the plurality of document images of the electronic document, wherein the obtained document images are extracted from the electronic document during the extraction; and
determining, based on the determined visual identifiers and the obtained document images, whether the extraction is verified.

2. The method of claim 1, further comprising:
analyzing, via machine vision, each obtained document image of the electronic document to determine data, wherein it is determined whether the extraction is verified further based on the determined data.

3. The method of claim 1, wherein determining whether the extraction is verified further comprises:
determining whether at least two of the obtained document images are duplicates.

4. The method of claim 1, wherein the visual identifiers are determined further based on metadata of the electronic document.

5. The method of claim 1, further comprising:
extracting the plurality of document images from the electronic document, when it is determined that the extraction is not verified.

6. The method of claim 1, wherein analyzing the electronic document further comprises:
identifying, in the electronic document, at least one key field and at least one value;
creating, based on the electronic document, a dataset, wherein the created dataset includes the at least one key field and the at least one value; and
analyzing the created dataset, wherein the at least one transaction parameter is determined based on the analysis.

7. The method of claim 6, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

8. The method of claim 7, wherein analyzing the electronic document further comprises:
performing optical character recognition on the electronic document.

9. The method of claim 1, wherein the at least one visual identifier is determined based on at least a structure of the created template and at least one predetermined required type of visual identifier.

10. A non-transitory computer readable medium having stored thereon instructions for causing a processing circuitry to perform a process, the process comprising:
analyzing an electronic document to determine at least one transaction parameter of a transaction, the electronic document including a plurality of document images;
creating a template for the transaction, wherein the template is a structured dataset including the determined at least one transaction parameter;
determining, for each document image of the electronic document, at least one visual identifier based on the created template, wherein each determined visual identifier is one of the at least one transaction parameter;
obtaining the plurality of document images of the electronic document, wherein the obtained document images are extracted from the electronic document during the extraction; and
determining, based on the determined visual identifiers and the obtained document images, whether the extraction is verified.

11. A system for verifying an extraction of a plurality of document images from an electronic document, comprising:
a processing circuitry; and
a memory, the memory containing instructions that, when executed by the processing circuitry, configure the system to:
analyze the electronic document to determine at least one transaction parameter of a transaction, the electronic document including the plurality of document images;
create a template for the transaction, wherein the template is a structured dataset including the determined at least one transaction parameter;
determining, for each document image of the electronic document, at least one visual identifier based on the created template, wherein each determined visual identifier is one of the at least one transaction parameter;
obtain the plurality of document images of the electronic document, wherein the obtained document images are extracted from the electronic document during the extraction; and
determine, based on the determined visual identifiers and the obtained document images, whether the extraction is verified.

12. The system of claim 11, wherein the system is further configured to:
analyze, via machine vision, each obtained document image of the electronic document to determine data, wherein it is determined whether the extraction is verified further based on the determined data.

13. The system of claim 11, wherein the system is further configured to:
determine whether at least two of the obtained document images are duplicates.

14. The system of claim 11, wherein the visual are is determined further based on metadata of the electronic document.

15. The system of claim 1, wherein the system is further configured to:
extract the plurality of document images from the electronic document, when it is determined that the extraction is not verified.

16. The system of claim 11, wherein the system is further configured to:
identify, in the electronic document, at least one key field and at least one value;
create, based on the electronic document, a dataset, wherein the created dataset includes the at least one key field and the at least one value; and
analyze the created dataset, wherein the at least one transaction parameter is determined based on the analysis.

17. The system of claim 16, wherein the system is further configured to:
analyze the electronic document to determine data in the electronic document; and
extract, based on a predetermined list of key fields, at least a portion of the determined data, wherein the at least a portion of the determined data matches at least one key field of the predetermined list of key fields.

18. The system of claim 17, wherein the system is further configured to:
perform optical character recognition on the electronic document.

19. The system of claim 11, wherein the at least one visual identifier is determined based on at least a structure of the created template and at least one predetermined required type of visual identifier.
